(19) United States
(12) Patent Application Publication
(10) Pub. No.: US 2006/0042157 A1
(43) Pub. Date: Mar. 2, 2006

(54) Candle

(76) Inventor: Kendall Peter Rycroft, Navarre, FL (US)

Correspondence Address: AKERMAN SENTERFITT, 801 PENNSYLVANIA AVENUE N.W., SUITE 600, WASHINGTON, DC, 20004, US

(21) Appl. No.: 11/030,081

(22) Filed: Jan. 7, 2005

Related U.S. Application Data
(60) Provisional application No. 60/604,437, filed on Aug. 26, 2004.

(51) Int. Cl. C11C 5/00

(52) U.S. Cl. 44/275

(57) ABSTRACT

The present invention relates to a candle which may contain fragrances to provide aromatherapy to a user while it bums, and which also liquefies when burning such that other ingredients contained in the candle, such as oils, can be poured or applied on the user's skin, to provide an enhanced appearance to the user's skin. The candle includes a soy wax candle body, and may include a combination of ingredients which provide fragrance, sheen and texture, color, and other properties which enhance the skin. The candle may be provided in a container which collects the liquefied candle.

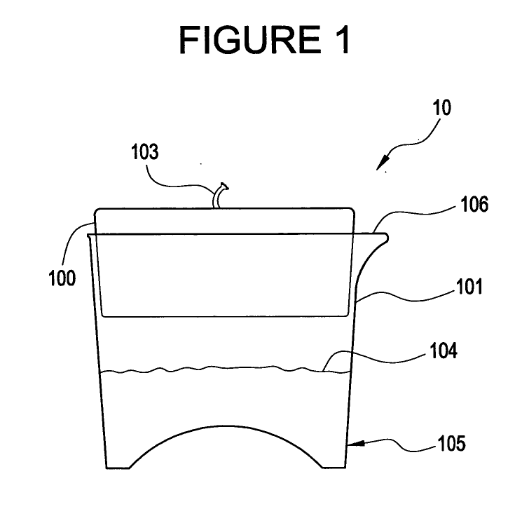

The present application relates to a candle which is made of a composition which can be liquefied and then applied to a user's skin to provide an enhanced appearance.

### BACKGROUND OF THE INVENTION

1. Field of the Invention

The present invention relates generally to the field of candles and to that of a candle which is made of a composition which can be liquefied and applied to the user's skin to provide an enhanced appearance.

2. Description of the Related Art

Candles which contain fragrances to provide aromatherapy for a user are well known in the art. In addition, it is well known in the art to provide oils of various kinds to a user, the oils which are massaged into the user's skin to provide aromatherapy or to enhance the appearance of the skin due to the oils' emollient properties.

It is also known in the art that candles made of soy products can be used to burn more cleanly and at a lower temperature than traditional wax candles. Further, soy candles which contain massage oils are known in the art, where a user can apply small amounts of the softened soy wax containing the massage oils, into the skin.

However, a candle which includes ingredients which may be used to provide aromatherapy, as well as which may contain oils for various purposes, such as emollience, sheen, etc., and which can be provided in a liquefied form to be applied or poured directly on a user's skin, would provide a unique combination of benefits to the skin to enhance the skin's appearance.

### SUMMARY OF THE INVENTION

The present invention combines the advantages of a candle which may provide aromatherapy to a user while it bums, and which may also contain other ingredients such as massage oils, such that when the candle is liquefied, it is able to be poured onto a user's skin to enhance the appearance of the skin.

In one embodiment consistent with the present invention the candle includes about 80% of total volume of soy wax; about 7% of total volume of shea butter; about 6% of total volume of oil; and about 6% of total volume of fragrance.

In another embodiment consistent with the present invention, the candle further includes at least one ingredient which provides color.

In yet another embodiment consistent with the present invention, the total volume of oil in the candle includes a combination of different oils.

In yet another embodiment consistent with the present invention, the oil in the candle is olive oil.

In yet another embodiment consistent with the present invention, the candle includes a lead-free wick.

In yet another embodiment consistent with the present invention, a candle includes about 80% of total volume of soy wax; about 7% of total volume of shea butter; about 6% of total volume of oil; and about 6% of total volume of fragrance; wherein the soy wax candle body is liquefied upon burning and adapted to be applied on a user's skin.

In yet another embodiment consistent with the present invention, the candle apparatus includes a candle; and a container in which the candle is disposed; wherein the candle is disposed in the container such that when the candle bums, the candle liquefies and the resulting liquid is collected in the container.

In yet another embodiment consistent with the present invention, a candle apparatus includes a candle adapted to be liquefied; and means for collecting a completely liquefied candle.

There has thus been outlined, some features consistent with the present invention in order that the detailed description thereof that follows may be better understood, and in order that the present contribution to the art may be better appreciated. There are, of course, additional features consistent with the present invention that will be described below and which will form the subject matter of the claims appended hereto.

In this respect, before explaining at least one embodiment consistent with the present invention in detail, it is to be understood that the invention is not limited in its application to the details of construction and to the arrangements of the components set forth in the following description or illustrated in the drawings. Methods and apparatuses consistent with the present invention are capable of other embodiments and of being practiced and carried out in various ways. Also, it is to be understood that the phraseology and terminology employed herein, as well as the abstract included below, are for the purpose of description and should not be regarded as limiting.

As such, those skilled in the art will appreciate that the conception upon which this disclosure is based may readily be utilized as a basis for the designing of other structures, methods and systems for carrying out the several purposes of the present invention. It is important, therefore, that the claims be regarded as including such equivalent constructions insofar as they do not depart from the spirit and scope of the methods and apparatuses consistent with the present invention.

### BRIEF DESCRIPTION OF THE DRAWINGS

The FIGURE is a perspective view of a container in which the candle of the present invention is disposed.

### DETAILED DESCRIPTION OF THE INVENTION

The present invention relates to a candle which may contain fragrances to provide aromatherapy to a user while it bums, and which also liquefies when burning such that other ingredients contained in the candle, such as oil and butter, can provide an enhanced appearance to a user's skin when the liquefied candle is poured on the user's body.

In one embodiment consistent with the present invention, the candle may be made entirely from natural soy wax, which bums at a lower temperature than traditional paraffin candles, and which bums cleanly with almost no soot. However, another composition may be used if it provides the same advantages as natural soy wax.

The natural soy wax may be combined with other ingredients, whether for emollient properties, or which provide fragrances for aromatherapy, or for other desired properties, such as providing a sheen to the skin, or providing a light feel of the oils on the skin etc.

The ingredients added to the candle may include oils, such as massage oils, and may be supplied in any amount necessary to provide the desired advantageous properties, such as emollience, sheen, etc., to the user. The ingredients can be provided in various combinations and in differing strengths, with one another to provide varying properties which are advantageous to the user.

In one embodiment consistent with the present invention, the candle may include, in addition to all natural soy wax, ingredients such as, for example, shea butter, to provide an enhanced appearance to the skin.

In another embodiment consistent with the present invention, the candle may include ingredients, such as oils, to provide fragrance, to provide sheen, to provide a light feel of the composition on the skin, or to provide other properties advantageous to an enhanced appearance to the skin, or for increased liquefaction of the candle.

Examples of such oils include olive oil, avocado oil, castor oil, etc., and fragrance oil (i.e., lavender, jasmine, etc.), but other oils which provide any of these properties or additional properties which are appropriate for enhancing the appearance of the skin or which improve the aroma of the candle, can be used singly or in different combinations.

In addition, in another embodiment consistent with the present invention, compositions which improve the general appearance of the skin, such as shea butter, vitamin E oil or olive oil may be used singly or in various combinations.

Other ingredients which provide safer burning or slower burning of the candle etc., may also be added to the candle, as desired.

Finally, in another embodiment consistent with the present invention, at least one color may be added as an ingredient to change the visual appearance of the candle.

The amount of the ingredients provided with the natural soy wax candle, may vary, but are provided in the amounts necessary to provide the moisturizing, sheen, fragrance, or other properties desired.

In one example, the candle may include about 8 ounces of natural soy wax, about a tablespoon of shea butter, about a tablespoon of olive oil, and about a tablespoon of fragrance oil to make up a total of about 10 ounces in total weight/volume.

In this exemplary candle, the candle would include percentages that would approximate about 80% of total volume of soy wax, about 7% of total volume of shea butter, about 6% of total volume of olive oil, and about 6% total volume of fragrance). However, these amounts can vary in range if they still provide an enhanced appearance to the skin.

All the ingredients provided in the candle are natural and safe to be provided on the skin to improve the skin's appearance.

In one embodiment consistent with the present invention, the candle is provided with a lead-free cotton wick, but a wick of any appropriate material (i.e., hemp etc.) which allows the candle to bum and be liquefied in a desired timeframe, can be used.

In one embodiment consistent with the present invention, an apparatus 10 for providing the candle 100 of the present invention is shown in the FIGURE. In the apparatus 10, the candle 100 is placed in a container 101 and fitted to the neck of the container 101 as shown in the FIGURE. However, any suitable container 101 may be used which can accommodate the candle 100 such that it allows the liquid generated by the burning and liquefaction of the candle 100 to be collected.

Further, the candle 100 may be provided in any suitable shape for disposition in the desired container 101.

In operation, after the user lights the wick 103 of the candle 100, the candle 100 bums and liquefies, and the liquid 104 flows downward and is held in the bottom 105 of the container 101 without solidifying. While the candle 100 bums, it may provide a fragrance which provides aromatherapy to the user.

Once the wick 103 is burnt through, and the candle 100 is liquefied and all the liquid 104 is collected in the bottom 105 of the container 101, which is a means for collecting the liquefied candle. The liquid 104 in the bottom 105 of the container 101 can be poured out via the pour lip 106 of the container 101 by the user, onto the skin of the user. The user may massage the liquefied candle 104 into the skin to provide an improved appearance to the skin due to the included ingredients, such as, for example, shea butter, olive oil etc.

Although the user would likely pour the liquefied candle 104 onto the skin after the candle 100 is liquefied, if the liquid 104 is not poured onto the skin at the time of liquefaction, and the liquid 104 resolidifies in the container 101, the container 101 can be reheated to remelt the solidified candle 100 for use.

Since the ingredients chosen are safe to be used on the skin, the user would have the unique combined advantages of an aromatherapy candle and massage oils in a single product that would enhance the appearance of the skin.

It should be emphasized that the above-described embodiments of the invention are merely possible examples of implementations set forth for a clear understanding of the principles of the invention. Variations and modifications may be made to the above-described embodiments of the invention without departing from the spirit and principles of the invention. All such modifications and variations are intended to be included herein within the scope of the invention and protected by the following claims.

What is claimed is:

1. A candle comprising:
about 80% of total volume of soy wax;
about 7% of total volume of shea butter;
about 6% of total volume of oil; and
about 6% of total volume of fragrance.

2. The candle of claim 1, further comprising:
at least one ingredient which provides color.

3. The candle of claim 1, wherein said total volume of oil comprises a combination of different oils.

4. The candle of claim 1, wherein said oil is olive oil.

5. The candle of claim 1, further comprising:
a lead-free wick.

6. A candle comprising:
about 80% of total volume of soy wax;
about 7% of total volume of shea butter;
about 6% of total volume of oil; and
about 6% of total volume of fragrance;
wherein said soy wax candle body is liquefied upon burning and the liquefied candle is adapted to be applied on a user's skin.

7. A candle apparatus, comprising:
a candle; and
a container in which said candle is disposed;
wherein said candle is disposed in said container such that when said candle bums, said candle liquefies and the resulting liquid is collected in said container.

8. The candle apparatus of claim 7, wherein said candle comprises:
about 80% of total volume of soy wax;
about 7% of total volume of shea butter;
about 6% of total volume of oil; and
about 6% of total volume of fragrance.

9. The candle apparatus of claim 8, wherein said candle further comprises:
at least one ingredient which provides color.

10. The candle apparatus of claim 8, wherein said total volume of oil comprises a combination of different oils.

11. The candle apparatus of claim 8, wherein said oil is olive oil.

12. The candle apparatus of claim 8, wherein said candle further comprises:
a lead-free wick.

13. A candle apparatus comprising:
a candle adapted to be liquefied; and
means for collecting a completely liquefied candle.
